(19) United States
(12) Patent Application Publication
(10) Pub. No.: US 2025/0120541 A1
(43) Pub. Date: Apr. 17, 2025

(54) COOKING SYSTEM

(71) Applicants: RINNAI CORPORATION, Nagoya-shi (JP); KYUSHU UNIVERSITY, NATIONAL UNIVERSITY CORPORATION, Fukuoka-shi (JP)

(72) Inventors: Takashi ITO, Nagoya-shi (JP); Yuka OKANO, Nagoya-shi (JP); Mahoko YOSHIDA, Nagoya-shi (JP); Yuko IWAMA, Nagoya-shi (JP); Tomomi YAMADA, Nagoya-shi (JP); Yojiro UMEDA, Nagoya-shi (JP); Daisuke SHIMABUKURO, Nagoya-shi (JP); Junya HAYASHI, Nagoya-shi (JP); Naoshige AKITA, Fukuoka-shi (JP); Kengo YAMADA, Fukuoka-shi (JP)

(21) Appl. No.: 18/912,675

(22) Filed: Oct. 11, 2024

(30) Foreign Application Priority Data
Oct. 16, 2023 (JP) 2023-178115

(51) Int. Cl. A47J 36/32; A47J 27/00; H04W 4/80

(52) U.S. Cl. CPC A47J 36/321; A47J 27/004; H04W 4/80

(57) ABSTRACT

In a cooking system (100), a cooking control part (52) has a terminal communication part (57) that performs one-to-one communication with each of first through third communication parts (17, 27, 37A, 37B). The first communication part (17) sends a state of a heating part (11) ascertained by a heating control part (12) to the terminal communication part. The second communication part (27) sends detection results from a first state sensor (26) to the terminal communication part. The third communication part (37A, 37B) sends detection results from a second state sensor (36A, 36B) to the terminal communication part. Based on the information received by the terminal communication part, the cooking control part generates and sends a cooking command for the heating part from the terminal communication part to the first communication part. The heating control part controls the cooking (heating) based on the cooking command.

### TECHNICAL FIELD

The present invention generally relates to a cooking system for preparing food.

### BACKGROUND ART

An example of a known cooking system is disclosed in US 2016/0051078 A1. As shown in FIG. 6 to FIG. 13 of this publication, this cooking system comprises a cooking vessel (e.g., temperature sensing cooking equipment 630), a heated cooking appliance (e.g., cooktop 614), a cooking utensil (e.g., temperature probe 1220), cooking control parts (e.g., tablet computer 650), and input/output parts (e.g., displays 611, 1111; camera 698; wireless transmitter 676; wireless communication module 974; etc.).

The cooking vessel is a frying pan and accommodates material to be cooked, e.g., food and/or liquids, such as water. In addition, the cooking vessel has a temperature sensor and can send (transmit, in particular, wirelessly transmit) detection results from the temperature sensor. The heated cooking appliance has at least one gas burner, serving as a heating part that heats the cooking vessel. The cooking utensil is a temperature probe that measures the temperature within the cooking vessel and is capable of sending (transmitting, in particular, wirelessly transmitting) detection results. The cooking utensil is used together with the cooking vessel for cooking the food.

The cooking control part is a computing device in the form of a tablet computer, which is disposed in the vicinity of the heated cooking appliance, and can communicate with the cooking vessel, the heated cooking appliance, and the cooking utensil. The cooking control part execute programs to control the cooking of the food by automatically operating an adjustment tool (e.g., one or more of control devices (dials, knobs) 640a-640d) that adjusts the heating output of the gas burner of the heated cooking appliance, or by providing assistance, by way of display and/or audio, to instruct a user to manually operate (rotate) the adjustment tool.

The input/output parts are a display, an audio output device, and an input device, which are provided integrally with, or separate from, the cooking control part. Operations for cooking the food are input at (via) the input/output parts, which transmit operation information to the cooking control part, and are controlled by the cooking control part so as to output information for cooking the food.

As shown in FIG. 1 of the above-noted publication, the cooking vessel, the heated cooking appliance, the cooking utensil, the cooking control part, and the input/output parts can each be connected to a network or the like to perform one-way communication or two-way communication. This cooking system can thereby be linked with a computing device of a remote user, a cooking control coordination service computing system, a portable device of a local user, and the like.

However, the known cooking system described above is designed such that the heated cooking appliance, etc. require complex electronic circuits for making determinations and advanced communication parts, and therefore the system configuration is complicated, and the work of assembling the system in various places, other than kitchens, such as dining rooms, living rooms, and multi-purpose facilities, is complicated.

In addition, this known cooking system is configured so that the heating control part receives commands of some sort from a terminal other than the cooking control part, via the network or the like, without transiting the cooking control part, which can cause heating to start in the heating part, or the like. In this cooking system, there is a risk that information leaks will occur from the cooking vessel, the heated cooking appliance, and the cooking utensil, via the network or the like.

### SUMMARY OF THE INVENTION

Accordingly, it is one non-limiting object of the present teachings to disclose techniques for improving a cooking system such that a safe cooking system can be easily assembled and stably operated in various places with a simple configuration, thereby providing an improved ergonomic and convenient cooking system.

In one non-limiting aspect of the present teachings, a cooking system may comprise:
a cooking vessel that accommodates a material to be cooked (e.g., food and/or liquids, such as water);
a heated cooking appliance having at least one heating part configured to heat the cooking vessel;
a cooking utensil that is used together with the cooking vessel in order to cook the material to be cooked;
a cooking control part that centrally manages the cooking vessel, the heated cooking appliance, and the cooking utensil, so as to control cooking of the material to be cooked; and
one or more input/output parts provided integrally with, or separately from, the cooking control part, the input/output parts being configured to receive input(s) or instructions for cooking the material to be cooked and transmit information concerning the input(s) or the instructions to the cooking control part, and be controlled by the cooking control part to output information for cooking the material to be cooked,
wherein:
the heated cooking appliance has a heating control part that controls heating by the heating part and a first communication part;
the cooking vessel has a first state sensor that detects a state of the cooking vessel and a second communication part;
the cooking utensil has a second state sensor that detects a state of the material to be cooked and/or a state of an ingredient (e.g., a seasoning, flavoring, additive, etc.) to be added to the material to be cooked and a third communication part;
the cooking control part has a terminal communication part that performs one-to-one communication with each of the first communication part, the second communication part, and the third communication part;
the first communication part sends an ascertained state of the heating part, which the heating control part ascertains, to the terminal communication part;
the second communication part sends detection results from the first state sensor to the terminal communication part;
the third communication part sends detection results from the second state sensor to the terminal communication part;
based at least in part on information received by the terminal communication part, the cooking control part generates and sends a cooking command for the heating part from the terminal communication part to the first communication part; and
the heating control part is configured to control the cooking based at least in part on the cooking command.

In such a cooking system of the present teachings, a user can use a portable information terminal, such as a smartphone or a tablet, for the cooking control part and the input/output parts. In this case, the input/output parts are provided integrally with the cooking control part. Herein, the term “portable information terminal” is intended to encompass mobile devices and/or portable handheld computers having, e.g., a processor (e.g., one or more microprocessors), memory and/or storage, one or more programs stored in the memory and/or storage having instructions that when executed, enable the mobile device or portable handheld computer to perform one or more of the functions described herein, a battery that supplies power for the electronics of the mobile device, user interface, and circuitry capable of sending and receiving information (preferably wirelessly).

In addition, a user can use an information processing terminal, such as a personal computer or a dedicated terminal, as the cooking control part and can use a portable information terminal, such as a smartphone or a tablet, for the input/output parts. In this case, the input/output parts are provided separately from the cooking control part.

The user performs operational input at the input/output parts for performing cooking using the heated cooking appliance, the cooking vessel, and the cooking utensil. The cooking control part analyzes the cooking state based at least in part on the operational input, the detection results from the first state sensor, the detection results from the second state sensor, and the like, and transmits cooking commands to the heating control part via the terminal communication part and the first communication part.

The heating control part controls the cooking based solely on these cooking commands. Therefore, the heated cooking appliance does not require complex electronic circuits for making determinations or advanced communication parts. For example, the cooking control part can determine whether an abnormality such as overheating or heating failure has occurred in the heated cooking appliance based at least in part on the detection results from the vessel temperature sensor serving as the first state sensor of the cooking vessel, and transmit a cooking command for the heating part to the heating control part. Consequently, the heated cooking appliance does not require a temperature sensor that measures the temperature at the bottom of the cooking vessel or an electronic circuit that controls the cooking (heating) based at least in part on the temperature measured by the temperature sensor. Therefore, such a cooking system enables the size of the heated cooking appliance to be greatly reduced.

Since the cooking vessel likewise only transmits information to the cooking control part via the second communication part and the terminal communication part, neither complex electronic circuits for making determinations nor advanced (sophisticated, in particular expensive) communication parts are required.

Since the cooking utensil likewise only transmits information to the cooking control part via the third communication part and the terminal communication part, neither complex electronic circuits for making determinations nor advanced communication parts are required for this reason as well.

As a result, this cooking system is designed such that the heated cooking appliance, the cooking vessel, and the cooking utensil are simplified, which makes it easier to carry to various places other than kitchens, such as dining rooms, living rooms, outdoor patios, multi-purpose facilities, etc., together with the cooking control part and the input/output parts, enabling advanced (sophisticated) cooking to be performed in various places based at least in part on cooking commands output by the cooking control part.

In addition, in such a cooking system, since the cooking control part centrally manages the cooking vessel, the heated cooking appliance, and the cooking utensil, the heating control part does not cause the heating part to start heating or the like as a result of receiving a command of some sort from a terminal (mobile device, etc.) other than the cooking control part without transiting the cooking control part. In addition, in this cooking system, information leaks from the cooking vessel, the heated cooking appliance, and the cooking utensil can be prevented by the cooking control part.

Accordingly, the cooking system of the present teachings enables a highly safe (secure) system to be assembled and stably operated in various places with a simple configuration, whereby improved convenience can be achieved for users performing the cooking.

It is noted that, if the input/output parts are provided integrally with the cooking control part, it is not necessary to carry the cooking control part and the input/output parts separately, enabling even easier carrying to various places.

In another aspect of the present teachings, the first communication part, the second communication part, and the third communication part are preferably capable of performing short-range or near-field wireless communication.

In this case, the difficulty of making wired connections between the heated cooking appliance, the cooking vessel, and the cooking utensils and the cooking control part is eliminated, enabling even easier carrying to various places. Specific examples of short-range and near-field wireless communication include Wi-Fi®, Bluetooth®, ZigBee®, RFID (Radio Frequency Identification), NFC (Near Field Communication), and the like.

In another aspect of the present teachings, the cooking system of the present teachings preferably comprises a photographic (imaging) device having a camera capable of photographing (capturing one or more images of) the cooking vessel and the heated cooking appliance and a fourth communication part that performs short-range or near-field wireless communication. The fourth communication part preferably sends image information photographed by the camera to the terminal communication part. Furthermore, it is preferable that the cooking control part generates and sends cooking commands using the image information.

In this case, the cooking control part can use the image information photographed by the camera to analyze the cooking state in more detail and transmit advanced cooking commands to the heating control part. In addition, in this case, information leaks from the photographic device and invasion of privacy can be prevented by the cooking control part. Further, the user can save the cooking history as a video record.

In another aspect of the present teachings, the terminal communication part can preferably communicate with an external information processing terminal via a network. Furthermore, it is preferable that the cooking control part can selectively transmit the ascertained (detected) state of the heating part, the detection results from the first state sensor, the detection results from the second state sensor, and the image information from the camera to the information processing terminal.

In this case, this cooking system can be used in remotely-held cooking classes and the like. Furthermore, the instructor can remotely ascertain the state of a student's cooking in detail and can provide appropriate guidance. In addition, interactions between students can be promoted. At this time, information leaks and invasion of privacy can be prevented by the cooking control part.

In another aspect of the present teachings, it is preferable that the information processing terminal can generate and send cooking commands for the heating part to the cooking control part based at least in part on the information transmitted from the cooking control part. Furthermore, if the cooking control part has received a cooking command from the information processing terminal, the cooking control part preferably sends the cooking command from the terminal communication part to the first communication part when an operational input that approves the cooking command has been performed at (using) the input/output parts.

In this case, in a remotely-held cooking class or the like, a cooking command decided on by the instructor to improve the cooking state for the student's cooking vessel can be sent from the information processing terminal to the cooking control part. Furthermore, when the user has confirmed and approved that the cooking command can be safely performed (executed), the cooking control part can cause the heating control part to control the cooking (in particular, the heating output) based at least in part on the cooking command sent from the information processing terminal. This enables still further improvement of the safety of this cooking system.

Other aspects and advantages of the present invention will become apparent based on the working examples disclosed in the description below and the attached drawings, the diagrams set forth as examples in those drawings, and the concept of the present invention disclosed in the entirety of the specification and said drawings.

### BRIEF DESCRIPTION OF THE DRAWINGS

FIG. 1 is a perspective view of a cooking system of a working example.

FIG. 2 is a block diagram of the cooking system of the working example.

FIG. 3 is a front view of a portable information terminal.

FIG. 4 is a front view of a portable information terminal.

### DETAILED DESCRIPTION

Working examples according to the present teachings are described below, with reference to the drawings.

### Working Examples

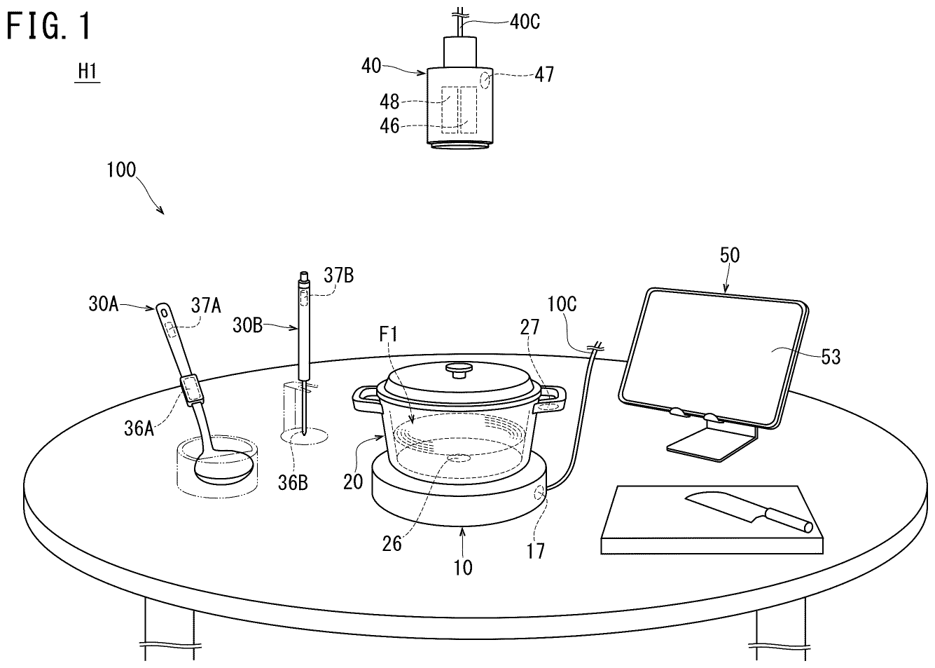

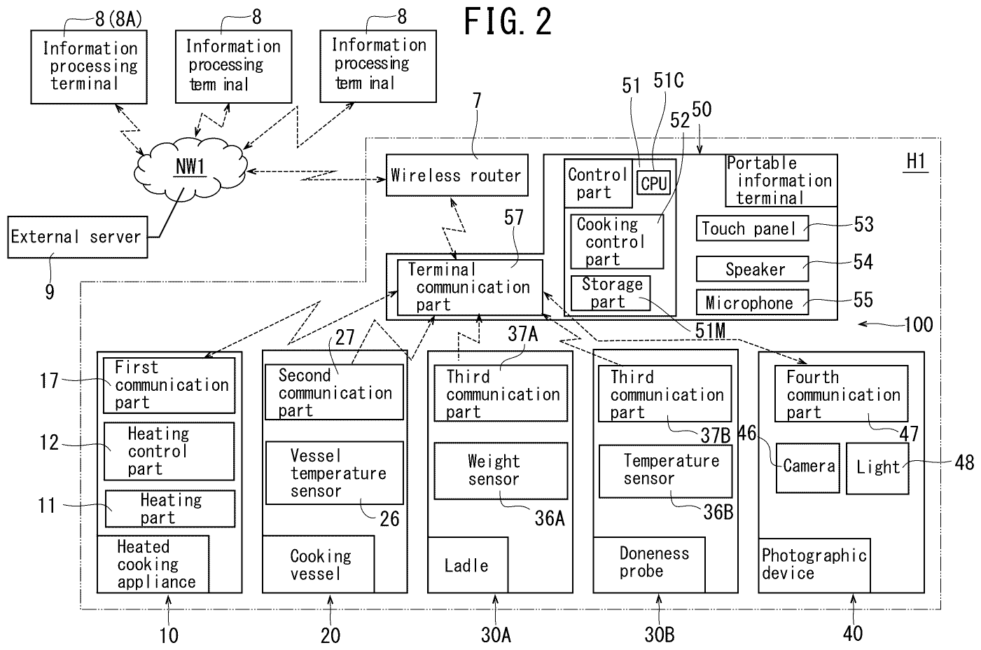

As shown in FIG. 1 and FIG. 2, the cooking system 100 of a working example serves as an exemplary, non-limiting embodiment of a cooking system of the present teachings. The cooking system 100 comprises a heated cooking appliance 10, a cooking vessel 20, a ladle 30A, a doneness probe (e.g., temperature sensor) 30B, a photographic device (imaging device) 40, and a portable information terminal (mobile device) 50.

The ladle 30A and the doneness probe 30B are each examples of a “cooking utensil” of the present teachings.

Since the heated cooking appliance 10, the cooking vessel 20, the ladle 30A, the doneness probe 30B, the photographic device 40, and the portable information terminal 50 each are sized (designed) to be easy to carry (i.e. portable), the cooking system 100 can be assembled in various places inside and outside a home H1. However, the present working example primarily describes an embodiment in which a user uses the cooking system 100 by placing the heated cooking appliance 10 or the like on a dining table in a living room, kitchen, dining room, outdoor patio, etc. of the home H1.

### Portable Information Terminal

The portable information terminal 50 is preferably a mobile device or hand-held computing device, such as a smartphone, a portable tablet computer, or the like, and is easily portable, e.g., by a user who will be handling the cooking in the home H1. As shown in FIG. 2, the portable information terminal 50 includes a control part 51, a touch panel 53, a speaker 54, a microphone 55, and a terminal communication part 57. In principle, a portable information terminal 50 according to the present teachings preferably includes one or more microprocessors, memory (volatile memory) and/or storage (non-volatile memory), one or more programs stored in the storage and containing instructions that, when executed, perform one or more of the methods described herein, and input/output devices, such as a touchscreen, mouse, joystick, display, speakers, etc. The portable information terminal 50 may include a rechargeable battery for powering the electronic devices contained therein and/or may include a power cord.

More specifically, the control part 51 is an electronic circuit unit configured to include: one or more central processing units (CPU) 51C; a storage part 51M having one or more memory and/or storage elements such as ROM, RAM, flash memory, etc., which are not shown; an interface circuit and the like, which are not shown. The control part 51 executes one or more programs stored in the memory and/or the storage elements to control processing relating to the operation of the portable information terminal 50.

As noted above, the storage part 51M stores various programs and setting information and the like for operating the portable information terminal 50. In addition, the storage part 51M stores various types of information obtained by the control part 51, as appropriate. The program(s) stored by the storage part 51M include(s) an application program (hereinafter referred to as a “cooking assistant application” or simply a “cooking app”) for operating (e.g., controlling at least in part and/or providing instructions, information, etc. to the user of) the cooking system 100.

The control part 51 has a cooking control part 52. The cooking control part 52 functions when the cooking assistant application is executed on the portable information terminal 50. The cooking control part 52 will be described in detail below.

The touch panel (touchscreen) 53 includes a display part that displays various types of information such as characters and images, and an input part, which covers the display part in a manner that allows viewing by the user and receives various inputs by way of operations performed by the user touching it with a fingertip.

The speaker 54 outputs, e.g., telephone audio of other parties when the telephone is used. In addition, the speaker 54 is also capable of outputting various types of information as audio when various application programs are executed.

The microphone 55 converts the user's speech into electronic audio signals when the telephone is used. In addition, the microphone 55 can also receive audio input such as operation instructions when various application programs are executed.

When using (executing) the cooking assistant application on the portable information terminal 50, it is noted that the touch panel 53, the speaker 54, and the microphone 55 serve as representative, non-limiting examples of “input/output parts” of the present teachings. The touch panel 53, the speaker 54, and the microphone 55 are provided integrally with the cooking control part 52.

The terminal communication part 57 is preferably configured to perform calls made using the frequency band of the mobile telephone (e.g., 4G or LTE, 5G, etc.). In addition, the terminal communication part 57 has built-in electronic circuits that perform short-range and/or near field wireless communication using, e.g., one or more of Bluetooth®, Wi-Fi®, ZigBee®, RFID, NFC or the like.

The terminal communication part 57 is preferably configured to connect to an external network NW1 via a wireless router 7 or the like installed in the home H1, and perform network communication with an external server 9 or a plurality of information processing terminals 8 or the like, connected to the network NW1. The external server 9 and each of the information processing terminals 8 are examples of an “external information processing terminal” of the present teachings.

The external server 9 is a server that holds (stores) various types of information that support the operation of the cooking system 100. The control part 51 is preferably configured to download the cooking assistant application by way of network communication with the external server 9, and store this in the storage part 51M.

When the user places material to be cooked (e.g., food, ingredients, etc.) F1, for example, solid ingredients for a stew, water serving as broth, various flavorings, and the like, in the cooking vessel 20, and cooks with the cooking system 100 as shown in FIG. 1, the cooking assistant application may be executed on the portable information terminal 50 to assist the user during the cooking operation.

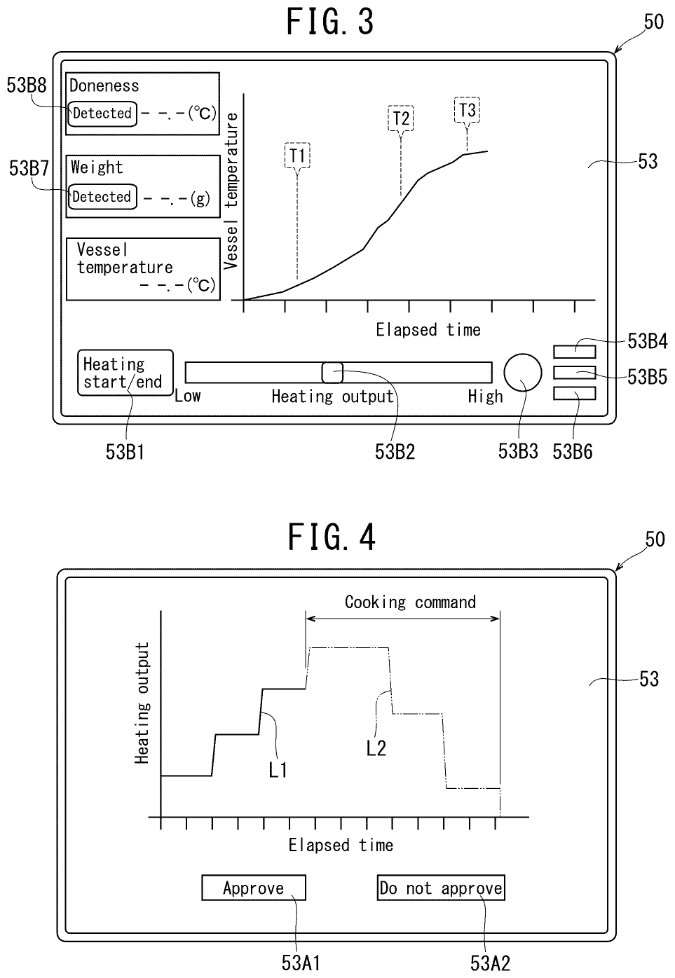

Then, as shown in FIG. 3, the touch panel 53 is controlled by the cooking control part 52 so as to output (e.g., display) information for cooking the material to be cooked F1 by way of one or more images, written instructions, audio outputs, etc. In addition, the touch panel 53 also displays operation buttons (e.g. icons, instruction boxes, etc.) for cooking the material to be cooked F1, for example, operation buttons 53B1 to 53B8.

If necessary, at this time, the speaker 54 is controlled by the cooking control part 52 and outputs audio information for cooking the material to be cooked F1.

Furthermore, operations for cooking the material to be cooked F1 are input to the touch panel 53 by way of the operation buttons 53B1 to 53B8 and the like, and operation information is transmitted to the cooking control part 52.

For example, when the user presses an operation button (heating start/end button) 53B1 once, the touch panel 53 transmits information for an operation that starts heating to the cooking control part 52. When the user presses the operation button (heating start/end button) 53B1 again, the touch panel 53 transmits information for an operation that ends the heating to the cooking control part 52. It is noted that, in order to prevent erroneous operations due to unintended contact by the user and the like, the heating start operation may require, e.g., a two-stage operation such as, pressing the operation button being once to display a pop-up message such as “Start Heating” together with additional display of an “OK” operation button, and then starting the heating when the “OK” button has been pressed. Of course, any such input instructions from the user could, in addition or instead, be input audibly via the microphone 55.

In addition, when the user slides the operation button (heat output adjustment button) 53B2 to the left or right, the touch panel 53 transmits information for an operation to adjust the level of the heat output to the cooking control part 52 (e.g., increasing heating output or decreasing heating output).

As was noted above, at this time, the microphone 55 is preferably configured to be controlled by the cooking control part 52, and an operation for cooking the material to be cooked F1 may be input by way of audio, instead of by way of touching the operation button on the touch panel 53, and operation information can also be transmitted to the cooking control part 52 in this manner.

### Heated Cooking Appliance

As shown in FIG. 1, the heated cooking appliance 10 is preferably a portable induction heating “IH” cooktop, which will also referred to as a tabletop IH cooking heater. In such an embodiment, the heated cooking appliance 10 has a power cable 10C connected to an electrical outlet in the home H1. The heated cooking appliance 10 is substantially disk-shaped. The cooking vessel 20 is placed on the upper surface of the heated cooking appliance 10. However, in other embodiments of the present teachings, the heated cooking appliance 10 may be, e.g., a portable cooktop, which uses a fuel gas such as, e.g., butane, propane, mixtures thereof, etc. as the fuel for generating heat, a hot plate that has electrical resistance elements for generating heat, etc. Of course, if desired, the present teachings also may be used with a built-in (i.e. non-portable) cooktop, range or stove that operates using natural gas, propane, electricity, etc., to generate heat for cooking.

As shown in FIG. 2, the heated cooking appliance 10 has a heating part 11, a heating control part 12, and a first communication part 17. When the power cable 10C is connected to the outlet, the heating control part 12 and the first communication part 17 enter a standby state, in which the power consumption is very low. Subsequently, when the cooking assistant application is executed (opened) on the portable information terminal 50, an operating state is entered. The heated cooking appliance 10 may have a power switch and may be configured to switch between a power “off” state and the standby state.

In the present working example, the heating part 11 is a high-frequency induction heating type heater, which is contained within the heated cooking appliance 10. By supplying electricity thereto, the heating part 11 generates electromagnetic fields that cause the cooking vessel 20, which is specifically designed for IH cooking and has been placed on the heated cooking appliance 10, to heat up.

The heating control part 12 controls heating by the heating part 11. The heated cooking appliance 10 does not require an operation button or the like, serving as a user interface, with which the user performs operational input to the heating part 11. In addition, the heated cooking appliance 10 does not require a temperature sensor that measures the vessel temperature of the cooking vessel 20. Therefore, the heating control part 12 is configured to perform control based on cooking commands sent by the cooking control part 52, which will be described below. However, in alternate embodiments of the present teachings, an operation (e.g., press) button, dial and/or a temperature sensor may be provided in or on the heated cooking appliance 10.

Specifically, when the cooking assistant application has been opened on the portable information terminal 50 (and is being executed) and the cooking assistant application has entered the operating state, the heating control part 12 controls the heating start, the heat output change, and the heating end of the heating part 11, based on cooking commands sent by the cooking control part 52. In addition, if the heating control part 12 has detected an abnormality, such as the voltage value or the current value of the power supplied to the heating part 11 reaching or exceeding an abnormal value (i.e. a predetermined threshold), this is determined to be a heating part 11 power supply abnormality, and the supply of power (electricity) to the heating part 11 is stopped. It is noted that a sensor used to determine whether the heating part 11 is experiencing a power supply abnormality and/or a sensor for preventing unsafe events such as the cooking vessel 20 overheating leading to the material to be cooked F1 catching fire may be provided and, in this case, the heating control part 12 stops the supply of power (electricity) to the heating part 11 based on output signals from such sensor(s).

The heating control part 12 is configured to ascertain the state of the heating part 11. The state of the heating part 11, which is ascertained by the heating control part 12, is treated as the ascertained state of the heating part 11. The ascertained state of the heating part 11 is, for example, heating part 11 heating start, heat output, heating end, power supply abnormality, or the like. Representative examples of a heating control part 12 according to the present teachings include, but are not limited to, e.g., a temperature sensor, a voltage detector, a current detector, etc.

As shown in FIG. 1, the first communication part 17 is disposed in the vicinity of the outer peripheral surface of the heated cooking appliance 10, in a built-in (integrated) manner. As shown in FIG. 2, the first communication part 17 is preferably configured to perform short-range and/or near-field wireless communication. In the present working example, the first communication part 17 performs short-range wireless communication using, e.g., Bluetooth®, which can perform wireless communications with a very low power consumption. When paired with the terminal communication part 57 of the portable information terminal 50, the first communication part 17 performs one-to-one short-range wireless communication with the terminal communication part 57 and is configured not to perform communication with a device other than with the terminal communication part 57.

When the cooking assistant application has been opened on the portable information terminal 50 and the cooking assistant application has entered the operating state, the first communication part 17 sends the ascertained (detected) state of the heating part 11, which the heating control part 12 has ascertained (detected), to the terminal communication part 57.

In addition, when the cooking control part 52 has sent a cooking command for the heating part 11 from the terminal communication part 57 as described below, the first communication part 17 receives the cooking command.

Because the heated cooking appliance 10 does not require complex electronic circuits for making determinations or advanced communication parts and is configured with minimal functions in this manner, it is small, excels in portability, and is easy to move in a convenient manner.

### Cooking Vessel

In FIG. 1, the cooking vessel 20 is shown as a two-handle pot with a lid, as one example according to the present teachings. However, cooking vessels 20 according to the present teachings are not particularly limited so long as the cooking vessel has a shape that is capable of holding the material to be cooked F1 and is constructed of a material that can be used safely with the particular type of heated cooking appliance 10 that the user has selected. Thus, as alternate examples, the cooking vessel 20 may be a one-handle pot with or without a lid, or may be a frying pan, or may be a variety of other cooking vessels. Of course, if the heated cooking appliance 10 functions based on induction heating, then the cooking vessel 20 also must be designed to convert electromagnetic energy into heat.

As shown in FIG. 2, the cooking vessel 20 has a vessel temperature sensor 26 and a second communication part 27. The vessel temperature sensor 26 and the second communication part 27 are supplied with power by a battery that is built into (contained within) the cooking vessel 20. The battery may be rechargeable (e.g., either using a cord or wirelessly (inductively) rechargeable) or it may be a disposable battery. The vessel temperature sensor 26 and the second communication part 27 are normally in a standby state in which the power consumption is very low. Then, when the cooking assistant application is opened (executed) on (by) the portable information terminal 50, an operating state is entered. The cooking vessel 20 may have a power switch and may be configured to switch between a power “off” state and the standby state.

As shown in FIG. 1, the vessel temperature sensor 26 is built into (embedded in) the bottom of the cooking vessel 20. The vessel temperature sensor 26 may be a well-known (conventional) temperature sensor that uses a thermistor or the like to generate an electrical signal based on the temperature that is sensed. In particular, the vessel temperature sensor 26 detects the temperature of the cooking vessel 20 when the operating state has been entered. The vessel temperature sensor 26 is an example of a “first state sensor” of the present teachings.

The second communication part 27 is disposed in the handle of the cooking vessel 20 in a built-in (embedded) manner. As shown in FIG. 2, the second communication part 27 may be configured to perform short-range or near-field wireless communication. In the present working example, the second communication part 27 preferably performs short-range wireless communication using Bluetooth® in the same manner as the first communication part 17. When paired with the terminal communication part 57 of the portable information terminal 50, the second communication part 27 performs one-to-one short-range wireless communication with the terminal communication part 57 and is configured not to perform communication with any other device than the terminal communication part 57.

When the operating state has been entered, the second communication part 27 sends (transmits) detection results from the vessel temperature sensor 26 to the terminal communication part 57. The detection results (vessel temperature) from the vessel temperature sensor 26 are displayed above the operation button (heating start/end button) 53B1 on the touch panel 53.

### Ladle

As shown in FIG. 1, the ladle 30A is used together with the cooking vessel 20 to cook the material to be cooked F1. The ladle 30A may also be referred to a dipper, and includes a handle and a scoop connected to the lower end of the handle.

As shown in FIG. 2, the ladle 30A has a weight sensor 36A and a third communication part 37A. The weight sensor 36A and the third communication part 37A are supplied with power by a battery that is built into (contained within) the ladle 30A. Again, the battery may be rechargeable or disposable, similar to the battery in the cooking vessel 20. The weight sensor 36A and the third communication part 37A are normally in a standby state, thereby minimizing the power consumption. Then, when the cooking assistant application is opened (executed) on (by) the portable information terminal 50, and the user further presses an operation button (weight detection button) 53B7 on the touch panel 53 shown in FIG. 3, the weight sensor 36A and the third communication part 37A enter an operating state for only a predetermined time. The ladle 30A may have a power switch and may be configured to switch between a power “off” state and the standby state.

It is noted that the cooking control part 52 may place the weight sensor 36A and the third communication part 37A in the operating state for only a predetermined time when an operational input that activates the weight sensor 36A has been performed by way of audio input to the microphone 55, instead of operating (manipulating, touching) the operation button 53B7 on the touch panel 53.

As shown in FIG. 1, the weight sensor 36A is disposed in the middle of the handle of the ladle 30A in a built-in (embedded) manner. The weight sensor 36A may be a well-known (conventional) weight sensor that uses a strain gauge or the like to convert the sensed weight into an electrical signal. The weight sensor 36A senses the weight of any material in the ladle 30A when the operating state has been entered.

The third communication part 37A is disposed at the upper end of the ladle 30A in a built-in (embedded) manner. As shown in FIG. 2, the third communication part 37A performs short-range or near-field wireless communication. In the present working example, the third communication part 37A preferably performs short-range wireless communication using Bluetooth® in the same manner as the first communication part 17 and the like. When paired with the terminal communication part 57 of the portable information terminal 50, the third communication part 37A performs one-to-one short-range wireless communication with the terminal communication part 57 and is configured not to perform communication with any other device than the terminal communication part 57.

When the operating state has been entered, the third communication part 37A sends (transmits) the detection results from the weight sensor 36A to the terminal communication part 57. As shown in FIG. 3, the detection results (weight value) from the weight sensor 36A are displayed in the vicinity of the operation button (weight detection button) 53B7 on the touch panel 53.

The user can weigh dry and/or wet ingredients, such as flavorings, liquids, etc. by pressing the operation button (weight detection button) 53B7 to zero the weight value (i.e. to obtain a tare weight or unladed weight), in a state in which the handle of the ladle 30A is held so that the scoop is suspended in the air, and then dropping (placing) the ingredient (e.g., flavoring, seasoning, liquid, etc.) into the scoop of the ladle 30A.

The weight sensor 36A is an example of a “second state sensor” of the present teachings. The weight sensor 36A detects the state of the ingredient (additive) to be added to the material to be cooked F1, which is to say the weight of the ingredient (additive, such as a flavoring).

### Doneness Probe

As shown in FIG. 1, the doneness probe 30B is used together with the cooking vessel 20 for cooking the material to be cooked F1.

The doneness probe 30B has a cylindrical handle and a small diameter rod-shaped detection part protruding downward from the lower end of the handle. The lower end of the detection part has a tapered shape.

As shown in FIG. 2, the doneness probe 30B has a temperature sensor 36B and a third communication part 37B. The temperature sensor 36B and the third communication part 37B are supplied with power by a battery (again, rechargeable or disposable) that is built into (contained within) the doneness probe 30B. The temperature sensor 36B and the third communication part 37B are normally in a standby state, thereby minimizing power consumption. Then, when the cooking assistant application is opened (executed) on the portable information terminal 50, and the user further presses the operation button (doneness detection button) 53B8 on the touch panel 53 shown in FIG. 3, the temperature sensor 36B and the third communication part 37B enter an operating state for only a predetermined time. The doneness probe 30B may have a power switch and may be configured to switch between a power “off” state and the standby state.

It is noted that the cooking control part 52 may place the temperature sensor 36B and the third communication part 37B in the operating state for only a predetermined time when an operational input that activates the temperature sensor 36B has been performed by way of audio input to the microphone 55, instead of operating (manipulating, touching) the operation button 53B8 on the touch panel 53.

As shown in FIG. 1, the temperature sensor 36B is built into (embedded in) the lower end of the detection part of the doneness probe 30B. The temperature sensor 36B is preferably a well-known (conventional) temperature sensor that uses a thermistor or the like to convert the detected temperature into an electrical signal. When the temperature sensor 36B has entered the operating state and the detection part is inserted into a solid or liquid ingredient in the material to be cooked F1, the doneness (° C.) of the ingredient(s) of the material to be cooked F1 is detected based on the sensed temperature.

The third communication part 37B is disposed at the upper end of the handle of the doneness probe 30B in a built-in (embedded) manner. As shown in FIG. 2, the third communication part 37B performs short-range or near-field wireless communication. In the present working example, the third communication part 37B preferably performs short-range wireless communication using Bluetooth® in the same manner as the first communication part 17 and the like. When paired with the terminal communication part 57 of the portable information terminal 50, the third communication part 37B performs one-to-one short-range wireless communication with the terminal communication part 57 and is configured not to perform communication with any other device than the terminal communication part 57.

When the third communication part 37B has entered the operating state, detection results from the temperature sensor 36B are sent (transmitted) to the terminal communication part 57. As shown in FIG. 3, the detection results (doneness) from the temperature sensor 36B are displayed in the vicinity of the operation button (doneness detection button) 53B8 on the touch panel 53.

By removing the lid of the cooking vessel 20, pressing the operation button (doneness detection button) 53B8 so as to place the temperature sensor 36B in the operating state, and then inserting the detection part of the doneness probe 30B into the ingredient(s) of the material to be cooked F1, the doneness (° C.) of the ingredient(s) of the material to be cooked F1 can be communicated to the user.

The temperature sensor 36B is an example of a “second state sensor” of the present teachings. The temperature sensor 36B detects the state of the material to be cooked F1, which is to say, the doneness of the ingredient(s) of the material to be cooked F1.

### Photographic Device (Imaging Device)

As shown in FIG. 1, the photographic device 40 is suspended from the ceiling above the heated cooking appliance 10. Although illustration is omitted, the photographic device 40 can instead be supported on a wall, a stand, or the like, in the surroundings, e.g., of a dining table or the like, on which the heated cooking appliance 10 is placed. In the alternative, the photographic device 40 may be permanently installed above a built-in cooktop, range or stove. The photographic device 40 preferably has a power cable 40C connected to an electrical outlet in the home H1, but in alternate embodiments also may be powered by a battery, such as a rechargeable or disposable battery.

As shown in FIG. 2, the photographic device 40 has a camera 46, a fourth communication part 47, and a light 48. When the power cable 40C is connected to an outlet, the camera 46, the fourth communication part 47, and the light 48 enter a standby state, thereby minimizing power consumption. Then, when the cooking assistant application is opened (executed) on (by) the portable information terminal 50 and the user performs an operational input, by way of the touch panel 53 or the microphone 55, so as to select (instruct) at least one of the camera 46 and the light 48 to operate, the selected one of the camera 46 and the light 48 and the fourth communication part 47 enter the operating state. The method of placing the photographic device 40 in the operating state is not limited to this, and various methods may be utilized, such as causing the operating state to be entered when the cooking assistant application has been opened (is being executed).

It is noted that the light 48 may also serve as a light fixture for a room having a dining table on which the heated cooking appliance 10 has been placed and/or for illuminating above a built-in cooktop, range or stove. In this case, the user may be able to switch the light 48 on and off independently of the execution of the cooking assistant application, by operating a remote control switch (not shown) dedicated to the light 48. In other embodiments of the present teachings, the light 48 may be omitted in situations in which the user will use the present cooking system in a well illuminated area.

As shown in FIG. 1, the camera 46 is capable of photographing (capturing image information of) the heated cooking appliance 10 and the cooking vessel 20. In addition, the camera 46 can photograph the top surface of the dining table on which the heated cooking appliance 10 is placed and the cooking utensils which are placed on the top surface, for example, the ladle 30A, the doneness probe 30B, a cutting board, a knife, or the like, as well as the material to be cooked, the flavorings, and the like, which are not shown. The camera 46 stores photographed images as image information, which may be still images or moving images (video). It is noted that the camera 46 may perform information processing on the image information (i.e. image processing, preferably digital image processing using well-known techniques), such as trimming the area outward of a predetermined appropriate range set by the user on the top surface of the dining table. In addition, the camera 46 may also perform information processing on the image information (i.e. image processing, preferably digital image processing using well-known techniques), such as extracting images of the heated cooking appliance 10 and the cooking vessel 20. Further, the camera 46 may be capable of recognizing not only visible light, but also infrared light, and may be configured to extract a temperature distribution from infrared light emitted from the material (food) that is being cooked in the cooking vessel 20.

The fourth communication part 47 is disposed in the vicinity of the outer peripheral surface of the photographic device 40 in a built-in (embedded) manner. As shown in FIG. 2, the fourth communication part 47 performs short-range or near-field wireless communication. In the present working example, the fourth communication part 47 preferably performs short-range wireless communication using Bluetooth® in the same manner as the first communication part 17 and the like. When paired with the terminal communication part 57 of the portable information terminal 50, the fourth communication part 47 performs one-to-one short-range wireless communication with the terminal communication part 57 and is configured not to perform communication with any other device than the terminal communication part 57.

When the operating state has been entered, the fourth communication part 47 sends (transmits) image information photographed (captured) by the camera 46 to the terminal communication part 57. The image information may be raw data or processed data in which, for example, a portion of the data has been extracted and/or otherwise processed at the camera 46. Further, the cooking control part 52 may (further) process the image information received by the terminal communication part 57.

The light 48 is controlled by the cooking control part 52 so as to change the illuminance during illumination. For example, the light 48 may increase the illuminance when the camera 46 has entered the operating state so that the quality of the image information of the camera 46 improves.

### Details of the Cooking Control Part

Each of the first communication part 17, the second communication part 27, the third communication parts 37A, 37B, and the fourth communication part 47 performs one-to-one short-range or near-field wireless communication with the terminal communication part 57 and is configured not to perform communication with any other device than the terminal communication part 57.

The cooking control part 52 thereby centrally manages the cooking vessel 20, the heated cooking appliance 10, the ladle 30A, the doneness probe 30B, and the photographic device 40, so as to control the cooking of the material to be cooked F1. Multiple cases (examples) of the manner in which a user may utilize the present cooking system will be described below.

### Case 1: If Users Use the Cooking System Around a Dining Table

Although it is common for multiple users to sit side-by-side when cooking in the kitchen, when a heated cooking appliance 10 or the like is used placed on a dining table, as shown in FIG. 1, with multiple users standing or sitting around the heated cooking appliance 10, which is located in the center of the dining table, a space is realized that promotes interaction.

When any of the users performs operational input by way of (using, via) the touch panel 53 or the microphone 55 so as to give heating start and heat output setting instructions for the heating part 11 in the heated cooking appliance 10, once the cooking control part 52 has confirmed that the heating part 11 is in an operable state based on the ascertained state of the heating part 11 obtained from the heating control part 12, heating start and heat output settings are sent from the terminal communication part 57 to the first communication part 17 as cooking commands for the heating part 11. As a result, based on the cooking commands, the heating control part 12 starts heating the heating part 11 and adjusts the heat output as set. The cooking control part 52 performs computational processing based on the ascertained state of the heating part 11 obtained from the heating control part 12, ascertains information such as the elapsed time after the heating start and the adjustment history of the heat output, which is the data resulting from combining changes in the heat output with a time axis, and adds this information to the ascertained state of the heating part 11 that is stored in the storage part 51M.

Furthermore, at all times, the cooking control part 52 ascertains the manner in which the temperature of the cooking vessel 20 that has been placed on the heated cooking appliance 10 changes upon heating by the heating part 11, based on the detection results from the vessel temperature sensor 26 obtained from the cooking vessel 20.

When the user performs operational input by way of (using, via) the touch panel 53 or the microphone 55 so as to give heat output change instructions for the heating part 11 in the heated cooking appliance 10, once the cooking control part 52 has confirmed that the heating part 11 is in state in which the heat output can be changed, based on the ascertained state of the heating part 11 obtained from the heating control part 12 and the detection results from the vessel temperature sensor 26 obtained from the cooking vessel 20, a heat output change is sent from the terminal communication part 57 to the first communication part 17 as a cooking command for the heating part 11. As a result, based on this cooking command, the heating control part 12 changes the heat output of the heating part 11.

If the cooking control part 52 determines, based on the detection results from the vessel temperature sensor 26 of the cooking vessel 20, that an abnormality, such as overheating or a heating failure (loss of heating output or ability), has occurred in the heated cooking appliance 10 during the operation of the heating part 11, a cooking command that brings about (executes) an abnormal stop of the heating part 11 is sent from the terminal communication part 57 to the first communication part 17. As a result, based on this cooking command, the heating control part 12 brings about (executes) an abnormal stop of the heating part 11.

As shown in FIG. 3, the cooking control part 52 causes the touch panel 53 to display a history of the vessel temperature changes over time, so that the user can easily ascertain the cooking history.

If support is performed (provided) for a cooking course that has been selected by a user, the cooking control part 52 notifies the user of the timing at which the heat output is to be changed, as indicated by the timings Tl to T3, notifies the user of the timing at which multiple ingredients (e.g., flavorings, seasonings, etc.) are to be added, and notifies the user of the timing at which the doneness of the ingredient(s) of the material to be cooked F1 is to be detected.

The cooking control part 52 records the weight value obtained from the ladle 30A as information for the cooking history, and provides a notification that prompts the user to add more of the ingredient (e.g., flavoring, seasoning, etc.) if the detected weight value is low. Of course, if the detected weight value is too high, then a notification may be provided to prompt the user to remove some of the ingredient from the ladle 30A before adding the ingredient to the material to be cooked F1 that is already in the cooking vessel 20.

The cooking control part 52 records the doneness obtained from the doneness probe 30B as information for the cooking history, and provides a notification that prompts the user to extend the heating time or change the heat output if the doneness is not sufficient.

The cooking control part 52 saves image information from the camera 46 obtained from the photographic device 40 as a video record of the cooking history. In addition, the cooking control part 52 can cause the image information of the camera 46 to be displayed on the touch panel 53 in real-time.

Further, the cooking control part 52 can utilize the image information of the camera 46 to analyze the cooking state in more detail and transmit advanced cooking commands to the heating control part 12. For example, the cooking control part 52 performs image analysis of changes and the like in the color of the material to be cooked F1 in the cooking vessel 20 and, if the material to be cooked F1 is about to boil over or burn, sends decrease-heating-output as a cooking command from the terminal communication part 57 to the first communication part 17. As a result, based on this cooking command, the heating control part 12 can prevent the material to be cooked F1 from boiling over or burning by decreasing the heat output of the heating part 11.

If the user performs operational input by way of (using, via) the touch panel 53 or the microphone 55 so as to give end-heating instructions for the heating part 11 in the heated cooking appliance 10, based on the ascertained state of the heating part 11 obtained from the heating control part 12, the cooking control part 52 sends end-heating as a cooking command for the heating part 11 from the terminal communication part 57 to the first communication part 17. As a result, based on this cooking command, the heating control part 12 ends heating of the heating part 11.

When the user ends cooking of the material to be cooked F1, the cooking history recorded by the cooking control part 52 is stored in the storage part 51M in a state that allows this to be reflected in the cooking from the next time onward. If the user provides an instruction to upload this cooking history to the external server 9 or to transmit it to a specific external information processing terminal 8, the cooking control part 52 sends the cooking history stored in the storage part 51M to the external server 9 or the specific external information processing terminal 8 via the terminal communication part 57, the wireless router 7, and the network NW1.

At this time, to prevent information leaks or invasion of privacy for various types of information such as image information, if necessary, the cooking control part 52 performs information processing that selectively extracts information that should not be sent or extracts only necessary information. In other words, the cooking control part 52 can selectively transmit the ascertained state of the heating part 11, the detection results from the vessel temperature sensor 26, the detection results from the weight sensor 36A, the detection results from the temperature sensor 36B, and the image information from the camera 46, to the external server 9 or the specific external information processing terminal 8. It is noted that the determination criteria for selective transmission of information by the cooking control part 52 are set by the user in advance, or on each occasion.

By producing (generating) data from the cooking history in this manner and making this available as a recipe, it is easier for multiple users to review the cooking process, thus making it easier to jointly make a “home recipe” and pass on the home recipe to children. In addition, this also serves as a reference when repeatedly experimenting with cooking in an attempt to reproduce the taste of a delicious dish (recipe) from a restaurant.

### Case 2: If the User Uses the Cooking System in a Remotely-Held Cooking Class

In case 2, as shown in FIG. 1, the installation state of the cooking system 100 in the home H1 is the same as in case 1. In case 2, as shown in FIG. 2, the external server 9 acts as a host server for the remotely-held cooking class.

An information processing terminal 8 (8A) among the plurality of external information processing terminals 8 is an information processing terminal used by the instructor of the remotely-held cooking class. The information processing terminals 8 other than the information processing terminal 8 (8A) among the plurality of external information processing terminals 8 are information processing terminals used by students of the remotely-held cooking class. The information processing terminals 8 used by the students constitute parts of cooking systems, similar to the cooking system 100, in the homes and the like where each is installed.

When a remotely-held cooking class in which a user in a home H1 participates as a student is started, the user can interact while viewing the state of the material to be cooked in the cooking vessels used by the instructor and each of the students, or while engaging with the instructor and other students, by way of the images displayed on the touch panel 53.

At this time, images of the material to be cooked F1 in the cooking vessel 20 and images of the user in the home H1 are photographed by the camera 46. The cooking control part 52 can selectively transmit the image information from the camera 46 to the external server 9 and the information processing terminals 8 of the instructor and other students in real time. It is noted that the configuration may be such that, as needed, the image of the user in the home H1 is photographed by a camera (not shown) mounted on or integral with the portable information terminal 50.

In addition, when the remotely-held cooking class is started, the cooking control part 52 can also selectively transmit the ascertained state of the heating part 11, the detection results from the vessel temperature sensor 26, the detection results from the weight sensor 36A, and the detection results from the temperature sensor 36B, to the external server 9 and the instructor's information processing terminal 8 (8A) in real-time.

It is noted that the determination criteria for selective transmission of information by the cooking control part 52 are set by the user in advance, or on each occasion.

In addition, the instructor's information processing terminal 8 (8A) sequentially transmits the guidance content for the recipe in the remotely-held cooking class to the portable information terminal 50 of the user, who is a student, and the information processing terminals 8 of the other students. The guidance content transmitted to the portable information terminal 50 is displayed on the touch panel 53. The user, who is a student, can, for example, change the heat output at the appropriate timing, add multiple ingredients (e.g., flavorings) at the appropriate timing(s), or detect the doneness of ingredients in the material to be cooked F1 at the appropriate timing(s), in keeping with the guidance content.

As shown in FIG. 4, the instructor's information processing terminal 8 (8A) can send a cooking command for the heating part 11 to the cooking control part 52 based on the information selectively transmitted and received from the cooking control part 52.

For example, the instructor may determine the cooking state for a user, who is a student, based on the history of changes in the heat output, the history of changes in the temperature of the cooking vessel 20, the cooking state of the material to be cooked F1 that is visible from the image information of the camera 46, and the like. Furthermore, if it is determined that the heat output is too low in the history of changes in the heat output (the polygonal line L1 indicated by the solid line in FIG. 4), in order to improve the cooking state for the user, a cooking command (the polygonal line L2 indicated by the dash-dot-dot line in FIG. 4), with which the heat output to the heating part 11 is increased for a predetermined time and then the heat output is lowered stepwise, is decided on and sent to the cooking control part 52.

If a cooking command has been received from the instructor's information processing terminal 8 (8A), the cooking control part 52 controls the touch panel 53 to provide a notification of the cooking command and to provide a notification that prompts for an operational input, as to whether or not to approve the cooking command.

Specifically, the cooking control part 52 provides a notification of the cooking command by displaying the polygonal line L2 indicated by the dash-dot-dot line in FIG. 4 on the touch panel 53 and provides a notification that prompts for an operational input, as to whether or not to approve the cooking command by displaying, e.g., an “Approve” button 53A1 and a “Do Not Approve” button 53A2 on the touch panel 53.

It is noted that, in this case, the cooking control part 52 can, as needed, also control the speaker 54 so as to provide an audio notification of the cooking command and to provide an audio notification that prompts for an operational input, as to whether or not to approve the cooking command.

When operational input that approves the cooking command has been performed at the touch panel 53, the cooking control part 52 sends the cooking command from the terminal communication part 57 to the first communication part 17. As a result, based on this cooking command, the heating control part 12 changes the heat output of the heating part 11 so as to be increased for a predetermined time, whereafter the heat output is lowered stepwise, as shown by the dash-dot-dot polygonal line L2 in FIG. 4.

It is noted that, in this case, the cooking control part 52 may send (transmit) the cooking command from the terminal communication part 57 to the first communication part 17 when an operational input that approves the cooking command has been performed by way of audio input to the microphone 55.

In the present working example, the cooking control part 52 sends (transmits) the cooking command from the terminal communication part 57 to the first communication part 17 only when the user performs an operational input that approves the cooking command.

It is noted that, since the cooking system 100 is designed such that the user approves cooking commands, in terms of the external server 9 and the information processing terminals 8 of other students as well, it may be possible to send cooking commands for the heating part 11 to the cooking control part 52 based on the information transmitted from the cooking control part 52. The cooking commands sent by the external server 9 may be decided by artificial intelligence (AI) that operates on the external server 9 so as to support the remotely-held cooking class.

In this way, when cooking by each of the students in the remotely-held cooking class ends, the instructor and each student or the like can show each other images of the completed dishes and the cooking history of each student can be shared with everyone, so as to promote interaction. At this time, by configuring the cooking control part 52 such that it selectively transmits information externally, it can prevent information leaks and invasion of privacy.

### Functions and Effects

In the cooking system 100 of the working example shown in FIG. 2, the user uses the portable information terminal 50, which is a mobile device such as a smartphone, tablet, or the like, as the cooking control part 52, the touch panel 53, the speaker 54, and the microphone 55. In this configuration, the touch panel 53, the speaker 54, and the microphone 55 are provided integrally with the cooking control part 52.

The user can perform operational input using the touch panel 53 and/or the microphone 55, in order to cook with the heated cooking appliance 10, the cooking vessel 20, the ladle 30A, and the doneness probe 30B. The cooking control part 52 analyzes the cooking state based on the operational input, the detection results from the vessel temperature sensor 26, the detection results from the weight sensor 36A, the detection results from the temperature sensor 36B, and the like, and transmits cooking commands to the heating control part 12 via the terminal communication part 57 and the first communication part 17.

The heating control part 12 controls the cooking operation based solely on these cooking commands. Therefore, the heated cooking appliance 10 does not require complex electronic circuits for making determinations or advanced communication parts. Specifically, based on the detection results from the vessel temperature sensor 26 of the cooking vessel 20, the cooking control part 52 determines whether or not an abnormality such as overheating or heating failure (loss of heating output or ability) has occurred in the heated cooking appliance 10, and transmits an appropriate cooking command for the heating part 11 to the heating control part 12. As a result, the heated cooking appliance 10 does not require a temperature sensor that measures the temperature at the bottom of the cooking vessel 20 or an electronic circuit that controls the cooking based on the temperature sensor. Therefore, this cooking system 100 enables the size of the heated cooking appliance 10 to be greatly reduced.

Since the cooking vessel 20 likewise only transmits the detection results from the vessel temperature sensor 26 to the cooking control part 52 via the second communication part 27 and the terminal communication part 57, neither complex electronic circuits for making determinations nor advanced communication parts are required.

Since the ladle 30A likewise only transmits the detection results from the weight sensor 36A to the cooking control part 52 via the third communication part 37A and the terminal communication part 57, neither complex electronic circuits for making determinations nor advanced communication parts are required.

Since the doneness probe 30B likewise only transmits the detection results from the temperature sensor 36B to the cooking control part 52 via the third communication part 37B and the terminal communication part 57, again neither complex electronic circuits for making determinations nor advanced communication parts are required.

As a result, this cooking system 100 is configured such that the heated cooking appliance 10, the cooking vessels 20, the ladle 30A, and the doneness probe 30B are simplified, making it easier to carry these, together with the cooking control part 52, the touch panel 53, the speaker 54, and the microphone 55, to various places other than kitchens, such as dining rooms, living rooms, outdoor patios, multi-purpose facilities, etc., enabling sophisticated cooking to be performed in various places based on cooking commands generated and output by the cooking control part 52.

In addition, in this cooking system 100, since the cooking control part 52 centrally manages the cooking vessel 20, the heated cooking appliance 10, the ladle 30A, and the doneness probe 30B, the cooking control part 12 does not cause the heating part 11 to start heating or the like as a result of receiving a command of some sort from a device other than the cooking control part 52 without transiting the cooking control part 52. Consequently, in this cooking system 100, information leaks from the cooking vessel 20, the heated cooking appliance 10, the ladle 30A, and the doneness probe 30B can be prevented by the cooking control part 52.

Accordingly, the cooking system 100 of the working example enables a highly safe system to be assembled and stably operated in various places with a simple configuration, whereby improved convenience can be achieved for users performing the cooking.

It is noted that, in the present working example, the touch panel 53, the speaker 54, and the microphone 55 are provided integrally with the cooking control part 52, and therefore the cooking control part 52 and the touch panel 53, the speaker 54, and the microphone 55 need not be carried separately, enabling even easier carrying to various places.

In addition, in this cooking system 100, the first communication part 17, the second communication part 27, and the third communication parts 37A and 37B are configured to perform short-range or near-field wireless communication. Owing to this configuration, the difficulties of making wired connections between the heated cooking appliance 10, the cooking vessel 20, the ladle 30A and the doneness probe 30B, and the cooking control part 52 are eliminated, which allows even easier carrying to and set up at various places.

Further, in this cooking system 100, the fourth communication part 47 that performs short-range or near-field communication sends (wirelessly transmits) image information photographed (captured) by the camera 46 to the terminal communication part 57. Furthermore, the cooking control part 52 sends a cooking command using the image information. Owing to this configuration, the cooking control part 52 can use the image information photographed by the camera 46 to analyze the cooking state in more detail and transmit advanced cooking commands to the heating control part 12. For example, the cooking control part 52 performs image analysis of changes and the like in the color of the material to be cooked F1 in the cooking vessel 20 and, if the material to be cooked F1 is about to boil over or burn, sends “decrease-heat-output” as a cooking command from the terminal communication part 57 to the first communication part 17. As a result, based on this cooking command, the heating control part 12 can prevent the material to be cooked F1 from boiling over or burning by decreasing the heat output of the heating part 11. In addition, owing to this configuration, information leaks from the photographic device 40 and invasion of privacy can be prevented by the cooking control part 52. Further, the user can save the cooking history as a video record. In addition, because the fourth communication part 47 is configured to perform short-range or near-field wireless communication, the difficulty of making a wired connection between the fourth communication part 47 and the cooking control part 52 is eliminated, enabling even easier carrying to and setting up at various places.

In addition, in this cooking system 100, the terminal communication part 57 can communicate with the external server 9 and the external information processing terminals 8 via the network NW1. Furthermore, the cooking control part 52 can selectively transmit the ascertained state of the heating part 11, the detection results from the vessel temperature sensor 26, the detection results from the weight sensor 36A, the detection results from the temperature sensor 36B, and the image information from the camera 46 to the external server 9 or the information processing terminals 8. Owing to this configuration, this cooking system 100 can be utilized in a remotely-held cooking class or the like. Furthermore, the instructor can remotely ascertain the state of the student's cooking in detail and can provide appropriate guidance. In addition, interactions between students can be promoted. At this time, information leaks and invasion of privacy can be prevented by the cooking control part 52.

Further, in this cooking system 100, the instructor's information processing terminal 8 (8A) can send a cooking command for the heating part 11 to the student's cooking control part 52 based on the information selectively transmitted and received from the student's cooking control part 52. Furthermore, as shown in FIG. 4, if the student's cooking control part 52 has received the cooking command (the polygonal line L2 indicated by the dash-dot-dot line in FIG. 4) from the instructor's information processing terminal 8 (8A), notification of the cooking command can be provided by displaying the polygonal line L2 indicated by the dash-dot-dot line in FIG. 4 on the student's touch panel 53, and notification that prompts for an operational input, as to whether or not the cooking command is approved, can be provided by displaying an “Approve” button 53A1 and a “Do Not Approve” button 53A2 on the student's touch panel 53. Furthermore, when an operational input that approves the cooking command has been performed at (using) the student's touch panel 53 or to the student's microphone 55, the cooking control part 52 sends (wireless transmits) the cooking command from the terminal communication part 57 to the first communication part 17. Owing to this configuration, a cooking command decided on by the instructor for improving the cooking state for a user who is a student in a remotely-held cooking class or the like can be sent from the instructor's information processing terminal 8 (8A) to the student's cooking control part 52. Furthermore, when the user has confirmed and approved the safety, the cooking control part 52 can cause the heating control part 12 to control the heating output based on the cooking command sent from the instructor's information processing terminal 8 (8A). This allows still further improvement of the safety of this cooking system 100.

The present teachings have been described above based on the working examples, but the present teachings are not limited to the working examples described above and, needless to say, can be applied with modifications as appropriate within a scope that does not depart from the spirit of the present teachings.

In the working examples, the input/output parts are a touch panel 53, a speaker 54, and a microphone 55, provided integrally with the cooking control part 52, but the present teachings are not limited to this configuration, and the input/output parts may be provided separately from the cooking control part. For example, a user may use an information processing terminal such as a personal computer or a dedicated terminal as the cooking control part and may use a touch panel, a speaker, and a microphone of a portable information terminal as the input/output parts. In this case, the touch panel, speaker, and microphone are provided separately from the cooking control part. In addition, configurations in which the cooking control part is provided integrally with the heated cooking appliance and the photographic (imaging) device, and a touch panel, speaker, and microphone of the portable information terminal are used as the input/output parts, or in which dedicated input/output parts are provided, are also included in the present teachings. If the cooking control part is provided integrally with the heated cooking appliance, it is not necessary for the terminal communication part of the cooking control part and the first communication part of the heated cooking appliance to communicate wirelessly, and thus, for example, a simple signal wire or wiring, without an electrical circuit, can be used as the first communication part. If the cooking control part is provided integrally with the photographic device, it is not necessary for the terminal communication part of the cooking control part and the fourth communication part of the photographic device to communicate wirelessly, and thus, for example, a simple signal wire or wiring, without an electrical circuit, can be used as the fourth communication part.

In the working examples, the cooking utensils are a ladle 30A and a doneness probe 30B, and the second state sensors are a weight sensor 36A and a temperature sensor 36B, but the present teachings are not limited to this configuration. For example, configurations in which the cooking utensil is a spatula, a scraper, or the like, and the second state sensor, which is provided in or on the spatula or the like, is a temperature sensor that detects the temperature of the material to be cooked, a concentration sensor that detects the salt concentration or the like of the material to be cooked, or the like, are also included in the present teachings.

In the working examples, the heated cooking appliance 10 is a portable IH stove having a heating part 11 of the high-frequency induction heating type, but the present teachings are not limited to this configuration. For example, configurations in which the heated cooking appliance is a portable cooktop, having a gas combustion type heating part and a heating control part that controls gas combustion by the heating part, and the heating part combusts fuel gas supplied from a gas (e.g., butane, propane, mixtures thereof, etc.) cylinder, are also included in the present teachings. In this case, the heating part has a fuel gas control valve that controls the supply of a fuel gas, adjustment of the amount supplied, and stopping, and an ignition device, and the heating control part controls the fuel gas control valve and the ignition device based on cooking commands, for the heating part, from the cooking control part. Therefore, it is not necessary that the heated cooking appliance has an operation button or the like serving as a user interface using which the user performs operational input for the heating part.

In the working examples, the photographic device 40 has a light 48, but the present teachings are not limited to this configuration. For example, configurations in which the light 48 is omitted from the photographic device 40 are also included in the present teachings.

Furthermore, the working examples are configured such that, in a remotely-held cooking class, a determination is made as to whether or not a user approves a cooking command sent from an external server 9 or an information processing terminal 8 and received by the terminal communication part 57 of the portable information terminal 50 via the network NW1, but the present teachings are not limited to this configuration. For example, configurations in which, in day-to-day cooking, a determination is made as to whether or not the user approves a cooking command decided by an acquaintance connected via the network NW1 or a cooking command decided by an artificial intelligence program stored on a cooking support server connected via the network NW1 are also included in the present teachings.

In the working examples, the cooking vessel 20 has a vessel temperature sensor 26 as a first state sensor, but the present teachings are not limited to this configuration. For example, a configuration in which a weight sensor that measures the weight of the material to be cooked, a concentration sensor that detects the salt concentration of the material to be cooked, and the like, is also included, and this may have a plurality of first state sensors. In this case, a vessel temperature sensor may be provided on the top surface of the heated cooking appliance 10 on which the cooking vessel 20 is placed, without providing a vessel temperature sensor 26 in the cooking vessel 20.

Further, the camera of the photographic device 40 may also be given a function as a vessel temperature sensor. As a specific example thereof, infrared rays emitted by the material to be cooked may be received by the camera and recognized as a temperature, and used together with the vessel temperature sensor 26.

In the working examples, each of the first communication part 17, the second communication part 27, the third communication parts 37A, 37B, and the fourth communication part 47 performs all communications using Bluetooth® as an example of performing one-to-one short-range wireless communication with the terminal communication part 57, but the present teachings are not limited to this configuration. For example, configurations in which the cooking vessel 20, the ladle 30A, and the doneness probe 30B, which are battery-operated, communicate using Bluetooth®, which allows for communication with low power consumption, and the heated cooking appliance 10 and the photographic device 40, which are connected to a commercial power source, and with which the amounts of information transmitted are relatively large, communicate by Wi-Fi®, are also included in the present teachings.

In the working examples, each of the first communication part 17, the second communication part 27, the third communication parts 37A, 37B, and the fourth communication part 47 performs one-to-one direct short-range wireless communication with the terminal communication part 57, but the present teachings are not limited to this configuration. For example, the information transmitted from the first communication part may be sent to the terminal communication part with the second communication part as a relay. In this case, the second communication part, which performs the relay, functions as a route for the first communication part and is treated as the first communication part. Further, each of the first communication part 17, the second communication part 27, the third communication parts 37A, 37B, and the fourth communication part 47 may communicate with the terminal communication part 57, relayed by another communication device (such as a router), which is not shown.

In the working examples, a case in which a cooking system is used around a dining table is described, but the present teachings are not limited to this configuration. For example, this may be configured to include a heated cooking appliance installed on a kitchen counter. In this case, the photographic device may be built into a range hood installed above the heated cooking appliance.

The present teachings can be used, for example, in a cooking system for performing cooking in a home, a cooking facility, or the like.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved cooking systems.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the cooking control part 52, is also understood as a corresponding method step or as a feature of a method step. In an analogous manner, aspects which have been described in the context of or as a method step also represent a description of a corresponding block or detail or feature of a corresponding device, such as the control unit.

Depending on certain implementation requirements, exemplary embodiments of the control unit of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the control unit have been identified as “parts” or “steps”, it is understood that such parts or steps need not be physically separate or distinct electrical components, but rather may be different blocks of program code that are executed by the same hardware component, e.g., one or more microprocessors.

### EXPLANATION OF THE REFERENCE NUMERALS

100: cooking system
F1: material to be cooked
20: cooking vessel
11: heating part
10: heated cooking appliance
30A, 30B: cooking utensils (30A: ladle, 30B: doneness probe)
52: cooking control part
53, 54, 55: input/output parts (53: touch panel, 54: speaker, 55: microphone)
12: heating control part
17: first communication part
26: first state sensor (vessel temperature sensor)
27: second communication part
36A, 36B: second state sensors (36A: weight sensor, 36B: temperature sensor)
37A, 37B: third communication parts
57: terminal communication part
46: camera
47: fourth communication part
40: photographic device
NW1: network
8, 9: external information processing terminals (8: information processing terminals, 9: external server)

1. A cooking system comprising:
a cooking vessel configured to hold a material to be cooked;
a heated cooking appliance having a heating part configured to heat the cooking vessel;
a cooking utensil configured to be used together with the cooking vessel to cook the material to be cooked;
a cooking control part configured to centrally manage the cooking vessel, the heated cooking appliance, and the cooking utensil and control cooking of the material to be cooked; and
input/output parts provided integrally with, or separately from, the cooking control part, the input/output parts being configured to (i) receive input(s) for cooking the material to be cooked and transmit input information to the cooking control part, and (ii) be controlled by the cooking control part to output information for cooking the material to be cooked,
wherein:
the heated cooking appliance includes a heating control part configured to control heating by the heating part, and a first communication part;
the cooking vessel includes a first state sensor configured to detect a state of the cooking vessel, and a second communication part;
the cooking utensil includes a second state sensor configured to detect a state of the material to be cooked and/or a state of an ingredient to be added to the material to be cooked, and a third communication part;
the cooking control part includes a terminal communication part configured to perform one-to-one communication with each of the first communication part, the second communication part, and the third communication part;
the first communication part is configured to send the state of the heating part detected by the heating control part to the terminal communication part;
the second communication part is configured to send detection results from the first state sensor to the terminal communication part;
the third communication part is configured to send detection results from the second state sensor to the terminal communication part;
the cooking control part is configured to generate a first cooking command for the heating part based on information received by the terminal communication part, and to send the first cooking command from the terminal communication part to the first communication part; and
the heating control part is configured to perform control based on the first cooking command.

2. The cooking system according to claim 1, wherein the first communication part, the second communication part, and the third communication part are configured to perform short-range or near-field wireless communication.

3. The cooking system according to claim 2, further comprising:
a photographic device including a camera configured to capture one or more images of the cooking vessel and the heated cooking appliance, and a fourth communication part configured to perform short-range or near-field wireless communication,
wherein:
the fourth communication part is configured to send image information captured by the camera to the terminal communication part, and
the cooking control part is configured to generate and send the first cooking command using the image information.

4. The cooking system according to claim 3, wherein:
the terminal communication part is configured to communicate with an external information processing terminal via a network, and
the cooking control part is configured to selectively transmit the detected state of the heating part, the detection results from the first state sensor, the detection results from the second state sensor, and the image information from the camera to the information processing terminal.

5. The cooking system according to claim 4, wherein:
the information processing terminal is configured to generate a second cooking command for the heating part based on information transmitted from the cooking control part, and to send the second cooking command to the cooking control part, and
the cooking control part is configured to send the second cooking command from the terminal communication part to the first communication part in response to the second cooking command received from the information processing terminal and an operational input approving the second cooking command having been performed at the input/output parts.
